(19) United States
(12) Patent Application Publication
(10) Pub. No.: US 2026/0217163 A1
(43) Pub. Date: Jul. 30, 2026

(54) ADJUSTMENT ASSEMBLY FOR A VEHICLE SEAT AND ASSOCIATED VEHICLE SEAT

(71) Applicant: Faurecia Sièges d’Automobile, Nanterre (FR)

(72) Inventors: Joffrey THIÉRION, Le Mesnil-Villement (FR); Johan TIREL, La Selle la Forge (FR); Damien GRIMAUD, Caligny (FR)

(21) Appl. No.: 19/461,676

(22) Filed: Jan. 27, 2026

(30) Foreign Application Priority Data
Jan. 27, 2025 (FR) FR 25 00826

(51) Int. Cl. B60N 2/235; B60N 2/90

(52) U.S. Cl. CPC B60N 2/2356; B60N 2002/957

(57) ABSTRACT

A vehicle seat and adjustment assembly for the vehicle seat. The adjustment assembly includes: a squab flange; a backrest flange, rotationally movable with respect to the squab flange; a device for rotationally locking the backrest flange with respect to the squab flange, movable between a locked position and an unlocked position for which the backrest flange is respectively rotationally locked and rotationally movable with respect to the squab flange; and a detector of the locked or unlocked position of the locking device. The locking device includes a cam, rotationally movable with respect to the squab flange and having a projecting stud. The detector includes a conductive element, elastically deformable and able to connect or disconnect two electrical terminals respectively to or from each other.

### TECHNICAL FIELD

The present invention relates to an adjustment assembly for a vehicle seat, of the type comprising: a squab flange; a backrest flange, rotationally movable with respect to the squab flange about an axis of rotation; a device for rotationally locking the backrest flange with respect to the squab flange, said locking device being movable between a locked position and an unlocked position, such that in said locked and unlocked positions, the backrest flange is respectively rotationally locked and rotationally movable with respect to the squab flange; and a detector of the locked or unlocked position of said locking device.

### BACKGROUND

A similar adjustment assembly is notably disclosed in document EP1954522.

It is advantageous to enable occupants of the vehicle to check whether or not the backrest of a seat is rotationally locked with respect to the squab. Indeed, an unlocked backrest can affect the security of users in the event of a collision.

Moreover, it is advantageous to secure the mechanism of the locking device of such an adjustment assembly. However, this type of securing generally means that the mechanism is invisible from the exterior, requiring the presence of a locking detector.

### SUMMARY

An object of the invention is to provide an adjustment assembly of the above-mentioned type, which is easy to use while enabling occupant notification that a backrest is rotationally unlocked.

To this end, there is provided an adjustment assembly of the above-mentioned type, wherein: the locking device comprises a cam, rotationally movable with respect to the squab flange about the axis, between the locked and unlocked positions of the locking device; the cam comprising: a main surface, substantially perpendicular to the axis, oriented towards the squab flange; and a stud projecting with respect to said main surface, towards said squab flange; the detector comprises: a first and a second electrical terminals; and a first conductive element, elastically deformable between a rest position and a stressed position; the detector is configured so that, in one of the rest position and of the stressed position of the first conductive element, the first and second electrical terminals are electrically disconnected from each other; and in the other of the rest position and of the stressed position of said first conductive element, the first and second electrical terminals are electrically connected to each other; and the adjustment assembly is configured so that, in one of the locked and unlocked positions of the locking device, the stud is at a distance from the first conductive element and said first conductive element is in the rest position; and in the other of the locked and unlocked positions of the locking device, the stud is in contact with the first conductive element and said first conductive element is in the stressed position.

According to other advantageous aspects of the invention, the adjustment assembly comprises one or more of the following features, taken alone or in any technically feasible combinations:
in the rest position of the first conductive element, the first and second electrical terminals are electrically disconnected from each other; and in the stressed position of said first conductive element, the first and second electrical terminals are electrically connected to each other;
in the unlocked position of the locking device, the stud is at a distance from the first conductive element and said first conductive element is in the rest position; and in the locked position of the locking device, the stud is in contact with the first conductive element and said first conductive element is in the stressed position;
the cam is arranged between the squab flange and the backrest flange with respect to the axis;
the detector is integral with the squab flange;
the adjustment assembly is configured so that the terminals and the first conductive element of the detector are arranged on either side of the squab flange;
the first conductive element of the detector is electrically connected to the first electrical terminal of said detector; said detector further comprises a second conductive element, electrically connected to the second electrical terminal; and in the locked and unlocked positions of the locking device, the first and second conductive elements are respectively in electrical contact with each other and spaced apart from each other;
the first and second conductive elements comprise a first and a second metal strip respectively.

The invention further relates to a vehicle seat comprising: a squab; a backrest; and at least one adjustment assembly as described hereinbefore, the backrest being able to be rotated with respect to the squab about the axis, the squab flange and the backrest flange of the at least one adjustment assembly being integral with the squab and the backrest respectively.

### BRIEF DESCRIPTION OF THE DRAWINGS

The invention will become clearer on reading the following description, given solely by way of non-limiting example, and made with reference to the drawings, wherein:

FIG. 1 is a side view of a vehicle seat structure according to one embodiment of the invention, comprising an adjustment assembly according to one embodiment of the invention;

FIG. 2 is a partial exploded view of the seat adjustment assembly shown in FIG. 1; and

FIGS. 3 and 4 are detail views of the adjustment assembly shown in FIG. 2, in a first and in a second configuration respectively.

### DETAILED DESCRIPTION

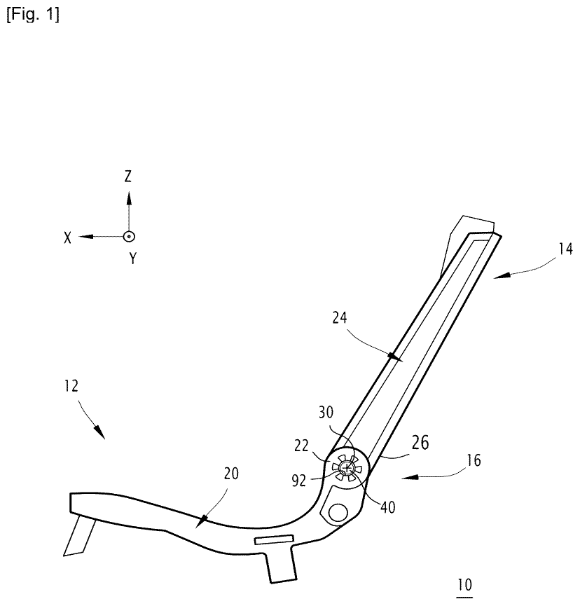

FIG. 1 shows a vehicle seat 10 according to one embodiment of the invention. The seat 10 is notably intended to equip a motor vehicle (not shown).

Only the structure of the seat 10 is visible in FIG. 1, as the trim is not depicted.

The seat 10 comprises: a squab 12, a backrest 14; and at least one adjustment assembly 16.

The squab 12 is intended to be assembled to a floor (not shown) of the vehicle. For example, the squab 12 is intended to be secured to said floor, or even to slide along rails (not shown) attached to said floor.

In the remainder of the description, an orthonormal reference (X, Y, Z) associated with the squab 12 is considered. The Z direction represents the vertical, while the horizontal X direction represents a direction of movement of the vehicle. In the remainder of the description, the terms “front” and “rear” refer to the X direction.

The squab 12 notably comprises a first and a second side elements 20. Only the first side element 20 is visible in FIG. 1.

Each side element 20 extends substantially along X. The first and second side elements 20 are substantially symmetrical to each other with respect to a median plane (X, Z) of the seat 10. Each side element 20 comprises a rear flank 22, arranged at a rear end of the squab 12.

The backrest 14 extends from the rear end of the squab 12 and comprises a first and a second side uprights 24. Only the first side upright 24 is visible in FIG. 1

Each side upright 24 extends substantially in a plane (X, Z). The first and second side uprights 24 are substantially symmetrical to each other with respect to the median plane (X, Z) of the seat 10. Each side upright 24 comprises a lower flank 26.

The backrest 14 can be pivoted with respect to the squab 12 about a first axis 30 of rotation parallel to the Y direction. More precisely, the lower flank 26 of each of the first and second side uprights 24 is hinged along the first axis 30, respectively to the rear flank 22 of the first and of the second side element 20.

In the embodiment depicted, the lower flanks 26 of the side uprights 24 are arranged between the rear flanks 22 of the side elements 20 along the first axis 30. More specifically, the side elements 20 of the squab 12 form the ends of the seat 10 in the Y direction.

Preferably, the seat 10 comprises a crossbar or control bar (not shown) which extends between the side elements 20 of the squab 12 and forms the first axis 30 of rotation.

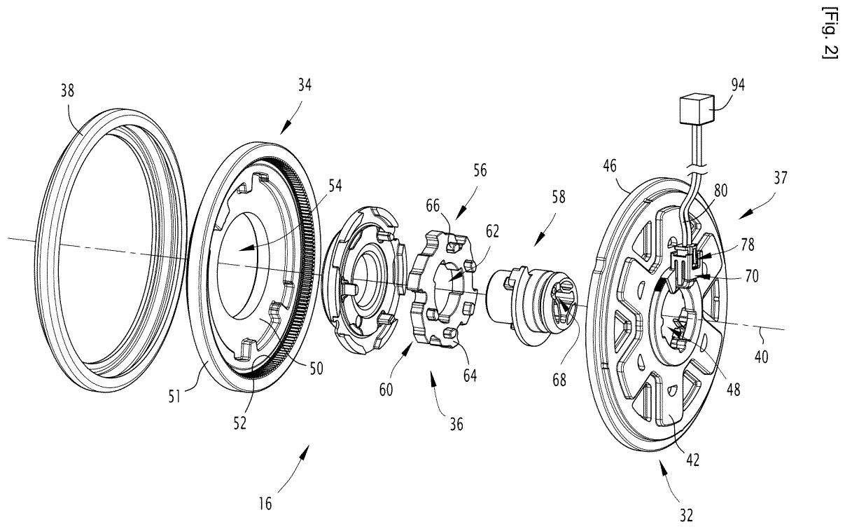

The adjustment assembly 16 will now be described on the basis of FIG. 2.

Said adjustment assembly 16 comprises: a squab flange 32; a backrest flange 34; a locking device 36; and a detector 37. In the embodiment depicted, the assembly 16 further comprises a closing ring 38.

The squab flange 32 has a substantially annular shape, arranged around a second axis 40. More precisely, the squab flange 32 comprises: a first 42 and a second 44 opposite faces; a substantially circular contour 46; and a first central opening 48, arranged around the second axis 40.

The backrest flange 34 also has a substantially annular shape, arranged around the second axis 40. The backrest flange 34 comprises notably: a so-called inner face 50; and a crown 51, projecting axially with respect to said inner face 50. In the embodiment depicted, the crown 51 comprises notches 52 facing the second axis 40.

The backrest flange 34 further comprises a second central opening 54, arranged around the second axis 40.

As described below, the backrest flange 34 can be pivoted with respect to the squab flange 32 about the second axis 40. The second face 44 of the squab flange 32 faces the backrest flange 34. The inner face 50 of the backrest flange 34 faces the squab flange 32.

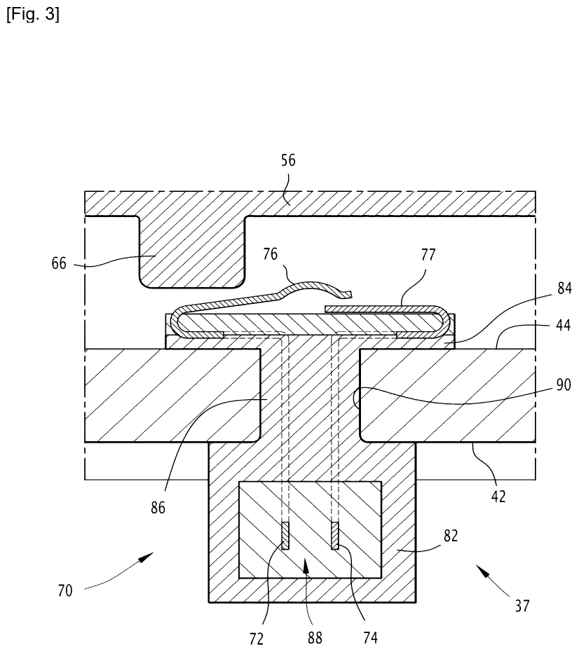

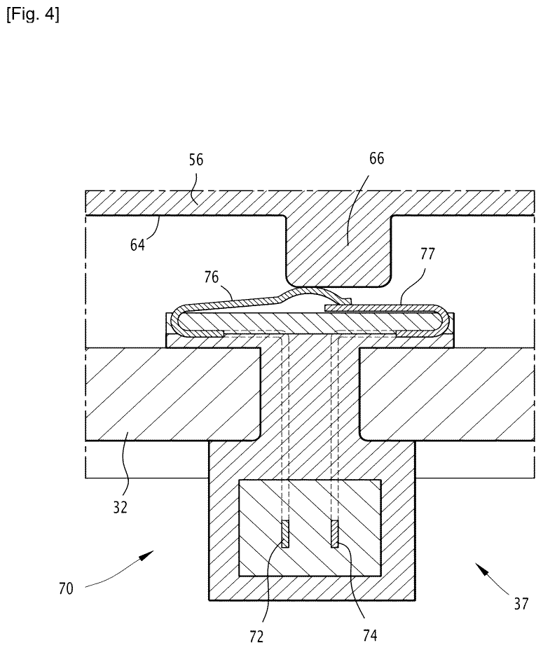

The locking device 36, partially shown in FIG. 2, is intended to rotationally lock or unlock the backrest flange 34 with respect to the squab flange 32, by means of notches 52 cooperating with radially movable bearing shells (not shown). In an unlocked position of the locking device 36, shown in FIG. 3, the backrest flange 34 is rotationally movable with respect to the squab flange 32 about the second axis 40. In a locked position of the locking device 36, shown in FIG. 4, the backrest flange 34 is rotationally locked with respect to the squab flange 32.

In the embodiment depicted, the locking device 36 notably comprises a cam 56 and a hub 58

The cam 56 also has a substantially annular shape, arranged around the second axis 40. The cam 56 has: a cam contour 60, intended to interact with other elements (not shown) of the locking device 36; and a third central opening 62, arranged around the second axis 40.

Along the second axis 40, the cam 56 is arranged between the squab flange 32 and the backrest flange 34. The cam 56 further comprises: a main surface 64, substantially perpendicular to the second axis 40 and oriented towards the squab flange 32; and at least one stud 66, projecting towards the squab flange 32 with respect to said main surface 64. In the embodiment depicted, the cam 56 comprises a number of studs 66 angularly spaced at regular intervals around the second axis 40.

The hub 58 has a tubular shape and is arranged along the second axis 40 in the first 48, second 54 and third 62 central openings. The hub 58 represents the second axis 40 of rotation of the cam 56, of the backrest flange 34 and of the squab flange 32 with respect to each other. Preferably, the hub 58 is also able to pivot about the second axis 40 with respect to the squab flange 32 and/or to the backrest flange 34 and/or to the cam 56.

The hub 58 also features a central cavity 68 extending along the second axis 40. As described below, said central cavity 68 is adapted to fit on the control bar (not shown) of the seat 10.

The locking device 36 further comprises other components (not shown), adapted to interact with the cam contour 60, as well as with the notches 52 of the backrest flange 34. Operation of the locking device 36 will be described later.

The detector 37, shown in FIGS. 3 and 4, comprises: a base 70; a first 72 and a second 74 electrical terminals; and a first 76 and a second 77 conductive elements. In the embodiment depicted, the detector 37 further comprises a plug 78 and electrical cables 80 integral with said plug, shown in FIG. 2.

The base 70 comprises an outer portion 82, an inner portion 84 and a junction 86 connecting said outer and inner portions. Preferably, the outer 82 and inner 84 portions and the junction 86 are formed in one piece.

The outer portion 82 of the base 70 forms a housing 88, adapted to receive the plug 78.

As shown in FIG. 2, the detector 37 is attached to the squab flange 32 at the first central opening 48. The outer portion 82 and the inner portion 84 are arranged in contact, respectively, with the first 42 and the second 44 faces of said squab flange 32. In the embodiment depicted, the junction 86 is arranged in a notch 90 provided in an edge of the first central opening 48.

The first 72 and second 74 electrical terminals are arranged in the housing 88, said electrical terminals being adapted to be electrically connected to the plug 78.

The first 76 and second 77 conductive elements are arranged on the inner portion 84 of the base 70. Preferably, as in the embodiment depicted, the first 76 and second 77 conductive elements are respectively a first and a second metal strip.

The first conductive element 76 is elastically deformable between a rest position and a stressed position. In the rest position, shown in FIG. 3, the first conductive element 76 is separated from the second conductive element 77. In the stressed position of the first conductive element 76, shown in FIG. 4, the first 76 and second 77 conductive elements are in electrical contact with each other.

The first 76 and second 77 conductive elements are electrically connected, respectively to the first 72 and to the second 74 electrical terminals.

The plug 78 can be electrically connected to the first 72 and second 74 electrical terminals. Preferably, as in the embodiment depicted, the plug 78 is removable with respect to the housing 88 on the base 70.

Preferably, with the exception of the plug 78 and cables 80, the adjustment assembly 16 has a one-piece configuration. In the embodiment depicted, the ring 38 for closing the assembly 16 is arranged at a periphery of the squab 32 and backrest 34 flanges, so as to close the space between said flanges. However, the closing ring 38 allows said squab 32 and backrest 34 flanges to pivot with respect to each other along the second axis 40

The adjustment assembly 16 described hereinbefore is incorporated into the seat 10 in such a way that the first 30 and second 40 axes merge.

More specifically, the squab flange 32 is attached to the rear flank 22 of the first side element 20 of the squab 12; and the backrest flange 34 is attached to the lower flank 26 of the first side upright 24 of the backrest 14. The adjustment assembly 16 is thus received between the first side element 20 of the squab 12 and the first side upright 24 of the backrest 14 along the first axis 30.

In the embodiment depicted, the rear flank 22 of the first side element 20 comprises an opening 92 arranged around the first axis 30. Said opening 92 is configured so as to reveal the squab flange 32 at the outer portion 82 of the detector 37. Said outer portion 82 of the detector 37 is thus accessible at one end of the seat 10 in the Y direction.

A method for operating the seat 10 and the adjustment assembly 16 will now be disclosed.

The seat 10 is assumed to be incorporated in a vehicle (not shown) such as a motor vehicle. The cables 80 of the detector 37 are connected to a control module 94 of said vehicle, schematically shown in FIG. 2. Said control module is for example capable of displaying a light signal on a dashboard (not shown) of the vehicle.

First of all, it is assumed that the device 36 for locking the assembly 16 is in the locking position, corresponding to the configuration shown in FIG. 4. In said locking position of the device 36, the backrest 14 is rotationally locked with respect to the squab 12 along the first axis 30.

In the locking position of the device 36, the cam 56 is in an angular position along the second axis 40 with respect to the squab flange 32, such that stud 66 is in contact with the first conductive element 76. Pressure on said stud 66 deforms said first conductive element 76 into a stressed position, establishing an electrical contact between the first 76 and second 77 conductive elements.

Thus, in the locking position of the device 36, the first 72 and second 74 electrical terminals are electrically connected to each other. Via the plug 78 and cables 80, the control module 94 therefore receives an electrical signal. The receipt of said electrical signal causes the control module 94, for example, to display a light signal identifiable by an occupant of the vehicle. The occupant can thus check that the backrest 14 is rotationally locked by the locking device 36.

If the occupant wishes to change an angle of the backrest 14 with respect to the squab 12, the occupant of the vehicle activates a control (not shown) to move the device 36 for locking the assembly 16 to the unlocking position. Such a control is for example a lever located on the seat 10.

During the actuation of said control, the cam 56 pivots through a non-zero angle with respect to the squab flange 32. An action of the cam contour 60 results in an angular release of the backrest flange 34 with respect to the squab flange 32.

It is thus possible to pivot the backrest 14 with respect to the squab 12 about the first axis 30, optionally using the motorized device (not shown) of the seat 10.

The non-zero angle of rotation of the cam 56 causes the stud 66 to move away from the first conductive element 76 in the unlocking position, as shown in FIG. 3. Said first conductive element 76 relaxes towards its rest position, interrupting the electrical contact between said first 76 and second 77 conductive elements.

In the unlocked position of the device 36, the first 72 and second 74 electrical terminals are electrically disconnected from each other and the control module 94 receives no electrical signal.

The light signal generated by said control module 94 is therefore interrupted. The occupant of the vehicle can thus check that the locking device 36 is in the unlocking position and that the backrest 14 is not rotationally locked.

When the occupant of the vehicle has reclined the backrest 14 to a satisfactory position, the occupant actuates a control (not shown) to return the locking device 36 of the assembly 16 to the locking position. The actuation of the control is achieved for example by pushing the backrest 14 forwards or backwards.

Such an actuation causes the cam 56 to pivot so as to bring the stud 66 back into contact with the first conductive element 76. This thus restores the electrical contact between the first 72 and second 74 terminals.

The mechanism of the assembly 16 is protected by the one-piece configuration of said assembly, defined by the squab 32 and backrest 34 flanges. The adjustment assembly 16 is easy to manufacture and to assemble with the other components of the seat 10, as the plug 78 can be easily connected to the electrical terminals 72, 74 at the end of the assembly operations.

1. An adjustment assembly for a vehicle seat, comprising:
a squab flange;
a backrest flange, rotationally movable with respect to the squab flange about an axis of rotation;
a device for rotationally locking the backrest flange with respect to the squab flange, said locking device being movable between a locked position and an unlocked position, such that in said locked and unlocked positions, the backrest flange is respectively rotationally locked and rotationally movable with respect to the squab flange; and
a detector of the locked or unlocked position of said locking device; wherein:
the locking device comprises a cam, rotationally movable with respect to the squab flange about the axis, between the locked and unlocked positions of the locking device; the cam comprising: a main surface, substantially perpendicular to the axis, oriented towards the squab flange; and a stud projecting with respect to said main surface, towards said squab flange;
the detector comprises: first and second electrical terminals; and a first conductive element, elastically deformable between a rest position and a stressed position;
the detector is configured so that, in one of the rest position and the stressed position of the first conductive element, the first and second electrical terminals are electrically disconnected from each other; and in the other of the rest position and the stressed position of said first conductive element, the first and second electrical terminals are electrically connected to each other; and
the adjustment assembly is configured so that, in one of the locked and unlocked positions of the locking device, the stud is at a distance from the first conductive element and said first conductive element is in the rest position; and in the other of the locked and unlocked positions of the locking device, the stud is in contact with the first conductive element and said first conductive element is in the stressed position.

2. The adjustment assembly according to claim 1, wherein, in the rest position of the first conductive element, the first and second electrical terminals are electrically disconnected from each other; and in the stressed position of said first conductive element, the first and second electrical terminals are electrically connected to each other.

3. The adjustment assembly according to claim 1, wherein, in the unlocked position of the locking device, the stud is at a distance from the first conductive element and said first conductive element is in the rest position; and in the locked position of the locking device, the stud is in contact with the first conductive element and said first conductive element is in the stressed position.

4. The adjustment assembly according to claim 1, wherein the cam is arranged between the squab flange and the backrest flange with respect to the axis.

5. The adjustment assembly according to claim 1, wherein the detector is integral with the squab flange.

6. The adjustment assembly according to claim 5, configured so that the terminals and the first conductive element of the detector are arranged on either side of the squab flange.

7. The adjustment assembly according to claim 1, wherein: the first conductive element of the detector is electrically connected to the first electrical terminal of said detector; said detector further comprises a second conductive element, electrically connected to the second electrical terminal; and in the locked and unlocked positions of the locking device, the first and second conductive elements are respectively in electrical contact with each other and spaced apart from each other.

8. The adjustment assembly according to claim 7, wherein the first and second conductive elements comprise respectively a first and a second metal strips.

9. A vehicle seat, comprising: a squab; a backrest; and at least one adjustment assembly according to claim 1, the backrest being able to be rotationally moved with respect to the squab about the axis, the squab flange and the backrest flange of the at least one adjustment assembly being integral respectively with the squab and the backrest.
